(19) United States
(12) Patent Application Publication
(10) Pub. No.: US 2021/0162543 A1
(43) Pub. Date: Jun. 3, 2021

(54) METHOD FOR TRIMMING A BENT TUBE

(71) Applicant: JENOPTIK Automatisierungstechnik GmbH, Jena (DE)

(72) Inventors: Sebastian STEINBACH, Jena (DE); Torsten SCHELLER, Jena (DE); Markus REMM, Magdala (DE); Torsten REICHL, Jena (DE); Jan LANGEBACH, Gera (DE)

(21) Appl. No.: 16/770,527

(22) PCT Filed: Dec. 5, 2018
(86) PCT No.: PCT/DE2018/100991

§ 371 Date: Jun. 5, 2020

(30) Foreign Application Priority Data
Dec. 7, 2017 (DE) 10 2017 129 107.5

(51) Int. Cl. B23K 26/38

(52) U.S. Cl. CPC B23K 26/38; B23K 2101/06

(57) ABSTRACT

A method for trimming a bent tube along an actual cutting contour, wherein a virtual tolerance envelope is calculated for the tube and a laser beam cutting the actual cutting contour is guided along a desired cutting contour related to the tolerance envelope, wherein the actual cutting contour is produced as a projection of the desired cutting contour or the laser beam is guided along the corrected desired cutting contour, which then corresponds to the actual cutting contour.

### PRIORITY CLAIM

The present application is a National Phase entry of PCT Application No. PCT/DE2018/100991, filed Dec. 5, 2018, which claims priority from German Patent Application 10 2017 129 107.5, filed Dec. 7, 2017, the disclosures of which are hereby incorporated by reference herein in their entirety.

### FIELD OF THE INVENTION

The invention relates to bent tubes. More specifically, the invention relates to methods and systems for advantageously trimming bent tubes.

### BACKGROUND OF THE INVENTION

Bent tubes exhibit high dimensional accuracy as far as their length and cross-section are concerned, but only very low dimensional accuracy in terms of the bending radius resulting from the two- or three-dimensional bending of the tubes. Variations in bending radius lead to variations in the line of the tube axis. This makes it difficult to perform cuts on the bent tube in front of and behind the tube bend in such a way that the resulting cutting contours have a reproducible position in relation to each other.

Two different methods for trimming three-dimensionally bent tubes or tube-like components (hereinafter jointly referred to as tubes) are known from the prior art. The two methods can be automated using a laser as the cutting tool.

In a first method known from practice, reference holes are formed in the bent tube before the cutting process step. Via these holes, the tube is received in a workpiece receptacle in order to position the tube with respect to the cutting tool. This holds the tube in a predetermined relative position of the reference holes to the workpiece receptacle. In automated cutting, the cutting contours along which the tube is cut are defined in terms of their spatial position relative to the position of the reference holes, regardless of a possible tolerance deviation of the tube bend from a desired value. The position of the reference holes is selected in such a way that a tube which can be fitted while in the receptacle is also within a specified tolerance range for the tube bend. This means that the criterion of the tube fitting or not also determines whether the tube is in or out of tolerance. Due to the geometric tolerances of the tubes, a defined automated pick-up by a gripper and fitting via the reference holes in the workpiece receptacle is not possible.

In a second method known from practice, the tube is inserted in a workpiece receptacle in which it comes to rest within a contact area. Again, the tubes must be inserted manually due to their geometric tolerances. Tubes that cannot be inserted to a specified extent have a bending radius which deviates from a desired value to such an extent that the tube bend no longer lies within a specified bending tolerance. A disadvantage in this case is, on the one hand, that due to the fixed position of the tube in the workpiece receptacle, the tube is accessible for a cutting tool such as a laser beam only to a limited extent. Areas concealed by the workpiece receptacle only become accessible for machining when the tube is moved to another workpiece holder. This leads to an increased expenditure of time and equipment. On the other hand, out-of-tolerance deviations in the shape of the tube outside the contact area of the receptacle are not detected, which may result in a cutting contour being cut out-of-tolerance on a tube and such a faulty tube being fed for further processing without being identified as faulty.

Especially in the manufacture of complex welded assemblies, such as tubular frames, it is particularly disadvantageous if it is not detected until the later process step of welding the tubes to each other that the tubes cannot be joined together at all interfaces because the cutting contours on individual tubes deviate too far from a specified desired position and the resulting deviations in the spatial position of the tubes relative to each other accumulate within a tolerance chain.

### SUMMARY OF THE INVENTION

It is the object of the invention to provide a method for trimming a tube that is comparatively more automated and allows the cutting contours to be produced with minimal tolerance.

This object is achieved by a method for trimming a bent tube along an actual cutting contour, wherein a virtual tolerance envelope with a desired cutting contour related to it is calculated for the tube and stored in relation to a spatially fixed coordinate system. The tube is picked up by a gripping arm of a feeding means with a known spatial position in the coordinate system. The contour of the tube is recorded by an optical measuring device with a known spatial position in the coordinate system and the tube is inserted into the virtual tolerance envelope to confirm that a shape tolerance for the tube has been observed and to ensure that the tube assumes a spatial position defined by the tolerance envelope. At the same time or thereafter, the gripping arm feeds the tube to a laser cutting device, which is arranged in a known spatial position in the coordinate system, the tolerance envelope being fed to the laser cutting device so that the laser cutting device assumes a predetermined position relative to the tolerance envelope and a laser beam emitted by the laser cutting device cuts the actual cutting contour on the tube.

Advantageously, the laser beam is guided along the desired cutting contour, cutting the actual cutting contour as a projection of the desired cutting contour on the tube. In this case, the projection of the desired cutting contour corresponds to a modification of the desired cutting contour.

It is also advantageous if the contour of the tube and its position in the tolerance envelope are recorded and stored, the desired cutting contour is corrected for the tube and the laser beam is guided along the corrected desired cutting contour, which then corresponds to the actual cutting contour.

For a faster pick-up of the tube by the gripping arm from a feed surface, the position of the tube on the feed surface is advantageously recorded beforehand by a further optical measuring device.

The real cutting contour (hereinafter referred to as the actual cutting contour) formed when trimming the tube is created by a cut-out on the shell of a tube or by a cut-off at the end of a tube.

For instance, in order to weld two tubes together, a resulting actual cutting contour, in the form of a cut-out area on the shell of the tube or an end face at the end of the tube, is respectively joined and welded to the shell or to a cut end face of another tube.

To produce the actual cutting edges with minimal tolerance means to cut them on the tube in such a way that a further tube welded thereto can be welded on with minimal positional deviation from a desired position, regardless of the shape deviation of the trimmed tube compared to an ideal trimmed tube.

It is essential to the invention that for cutting the actual cutting contour, the desired cutting contour is not defined in relation to the real tube, but in relation to the tolerance envelope calculated for the tube.

The desired cutting contour preferably lies within the tolerance envelope, preferably in the middle between the positions of two maximally deviating actual cutting contours on tubes inserted in the tolerance envelope.

One possibility is to produce the actual cutting contour as a projection of the desired cutting contour onto the real tube. Depending on the angular position of the laser beam in relation to the perpendicular at the points of incidence along the desired cutting contour, the desired cutting contour is projected onto the shell of the tube in a reduced, enlarged or otherwise modified manner. Ideally, the projection is performed in such a way that a different tube applied with its shell surface against the resulting actual cutting contour always has the same relative position to the tolerance envelope of the cut tube, completely independent of how the cut tube lies in the tolerance envelope. Thus, the positional tolerance of the tubes lying in the tolerance envelope does not enter into a tolerance chain.

Another possibility is to correct the desired cutting contour for the tube and to guide the laser beam along the corrected desired cutting contour, which then corresponds to the actual cutting contour. This requires recording not only the contour of the tube, but also its position in the tolerance envelope.

For each tube, an individual tolerance envelope is defined which is decisive for the shape tolerance of the respective tube. The tolerance envelope need not have the same dimensional deviations from an ideal tube over the length of the tube, as is shown in the drawings for the sake of clarity, but may be tolerated more tightly, for example, in the vicinity of intended actual interfaces. The tolerance envelope is stored with its assigned desired interfaces, relative to a spatially fixed coordinate system, with respect to which the equipment available for performing the method has a known, fixed spatial position. The tube picked up by the gripping arm for processing is fed to the optical measuring device, e.g. a 3D camera, which records the contour of the tube and its position in space. Next, the tube is inserted into the calculated tolerance envelope by moving the gripping arm which holds the tube. If insertion is not possible, the tube is out of shape tolerance and will not be further processed. The tolerance envelope may also cover only one or more individual sections of the tube. By knowing the position of the tolerance envelope in space, the tube then has a known spatial position and is fed relatively to the laser cutting device with this level of accuracy. This means that the tube does not occupy a reproducible spatial position relative to the laser cutting device. However, the tolerance envelope does assume a reproducible spatial position. Also, the tube does not have to be picked up in a reproducible relative position to the feed device. It is therefore sufficient if the tube is only pre-oriented on the feed surface so that the gripping arm can optimally grip the tube. Because the tube is not placed in a defined relative position to the feeding means by a defined pick-up, but only afterwards by being inserted in a relative position defined by the tolerance envelope with respect to the feeding means, the tube may be transferred, for example, after cutting the first actual cutting contour, to the gripping arm of the further feeding means, measured again, and inserted into the tolerance envelope again, thereby assuming a defined spatial position with respect to the further feeding means. This may be required, for example, if engagement around the tube is required in order to cut all actual interfaces on a tube.

The invention will be explained in more detail below with reference to an exemplary embodiment and drawings.

### BRIEF DESCRIPTION OF THE DRAWINGS

In the drawings:

FIG. 1a shows an ideal tube, lying ideally within a tolerance envelope, where a desired cutting contour and an actual cutting contour coincide;

FIG. 1b shows a tube lying tilted in the tolerance envelope;

FIG. 1c shows another tube lying tilted in the tolerance envelope, and

FIG. 2 shows a schematic diagram of a device suitable for performing the method.

### DETAILED DESCRIPTION

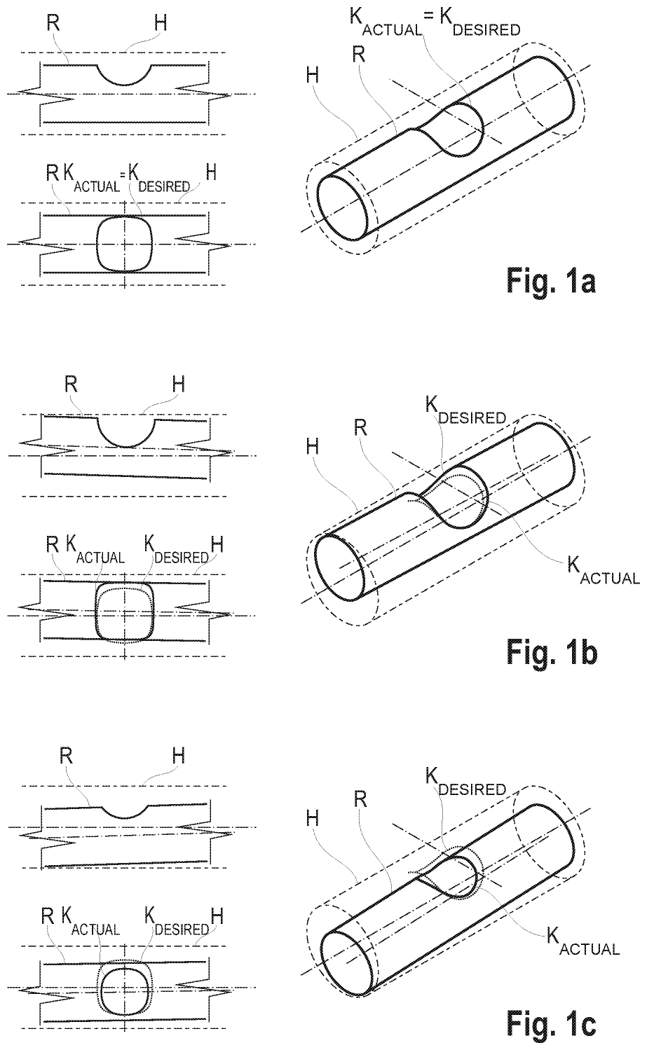

In a first process step, a tolerance envelope H is calculated for a bent tube R to be trimmed. It envelops the tube R either completely or only partially and is calculated in such a way that the tube R, which can be inserted completely into the tolerance envelope H, lies within a shape tolerance. The tolerance envelope H is stored together with the related desired cutting contours K_{DESIRED} for the tube R. Advantageously, the desired cutting contours K_{DESIRED} lie within the tolerance envelope H such that they coincide with the actual cutting contours K_{ACTUAL} along which the tube R is intended to be trimmed, when an ideal tube R lies ideally within the tolerance envelope H. FIG. 1a shows such a situation in a simplified manner, with reference to a straight tube R. The desired cutting contour K_{DESIRED} is advantageously defined such, with respect to the tolerance envelope H, that potential deviations in the position of the actual cutting contours K_{ACTUAL} cut on the tubes R lying differently in the tolerance envelope H can lie in front of and behind the desired cutting contour K_{DESIRED} in the direction of a laser beam directed at the tube R in order to lie close to the focus position of the laser beam guided along the desired cutting contour K_{DESIRED}.

FIG. 1b and FIG. 1c show the tube R tilted in the tolerance envelope H. Generally, the tube R will be inserted into the tolerance envelope H in such a way that its tube axis coincides, if possible, with the axis of the tolerance envelope H, which is always possible in the case of an ideal tube R without shape deviations. In the case of shape deviations, the tube axis and the axis of the tolerance envelope H are tilted with respect to each other at least in sections, which FIG. 1b and FIG. 1c are intended to show in a simplified manner.

The desired cutting contour K_{DESIRED}, related to the tolerance envelope H, is projected either onto the tubes R lying differently in the tolerance envelope H, in which case the actual cutting contours K_{ACTUAL} forming on the shell of the respective tube R exhibit a change in size and/or shape compared to the desired cutting contour K_{DESIRED}. Or the desired cutting contour K_{DESIRED} is corrected for to the shell of the respective tube R and the laser beam is guided along the corrected desired cutting contour K_{DESIRED/CORR}, which then corresponds to the actual cutting contour K_{ACTUAL}.

The tolerance envelope H and the desired cutting contours K_{DESIRED}, or only one desired cutting contour K_{DESIRED}, are stored with reference to a spatially fixed coordinate system. The spatial position of the technical means necessary for performing the method, such as a feeding device, tube feeder or feeding means 2 with a gripping arm 2.1, an optical measuring device 3, and a laser cutting device 4, within the coordinate system is known.

The technical means mentioned above are each connected to a storage and control unit 6.

To trim the tube R, the latter is picked up from a feed surface 1 by the gripping arm 2.1 of the feeding means 2 and transported to the optical measuring device 3, where the contour of the tube R is recorded. Knowing the spatial position of the optical measuring device 3, e.g. a 3D camera, the spatial position of the contour of the tube R is also known and the contour can be transformed into the tolerance envelope H, i.e. the tube R is moved by the gripping arm 2.1 until it fits into the virtual tolerance envelope H, which means that on the one hand compliance with a shape tolerance for the tube R is confirmed and on the other hand the tube R has assumed a spatial position defined by the tolerance envelope H.

The gripping arm 2.1 feeds the tube R to a laser cutting device 4. This may be done after the tube R has been transformed into the tolerance envelope H or during this process. By feeding the tolerance envelope H to the laser cutting device 4 in a predetermined relative position, the laser cutting device 4 assumes a predetermined position with respect to the tolerance envelope H and a laser beam emitted by the laser cutting device 4 cuts the actual cutting contour K_{ACTUAL} on the tube R.

In this case, the actual cutting contour K_{ACTUAL} may correspond to a reduced, enlarged or otherwise modified projection of the desired cutting contour K_{DESIRED} onto the shell of the tube R.

The laser beam is guided along the desired cutting contour K_{DESIRED}, e.g. at an angle to the perpendicular on the tolerance envelope H. By changing the angle, not only an enlargement or reduction but also a change in shape of the actual cutting contour K_{ACTUAL} compared to the desired cutting contour K_{DESIRED} can be achieved.

The actual cutting contour may also be a corrected desired cutting contour K_{DESIRED}/CORR. In order to calculate the corrected desired cutting contour K_{DESIRED}/CORR, not only the contour of the tube R is recorded and stored, but also its position in the tolerance envelope H. Knowing the position of the tube R in the tolerance envelope H, the desired cutting contour K_{DESIRED} can then be corrected for the tube R and the laser beam is guided along the corrected desired cutting contour K_{DESIRED}/CORR, which then corresponds to the actual cutting contour K_{ACTUAL}.

Advantageously, before the tube R is picked up from the feed surface 1 by the gripping arm 2.1, the position of the tube R on the feed surface 1 is recorded by a further optical measuring device 5. This makes it possible to determine whether an intended number of tubes R lie on the feed surface 1 and how they lie on the feed surface 1 in order to be able to pick them up safely with the gripping arm 2.1, even if they lie in a non-reproducible position.

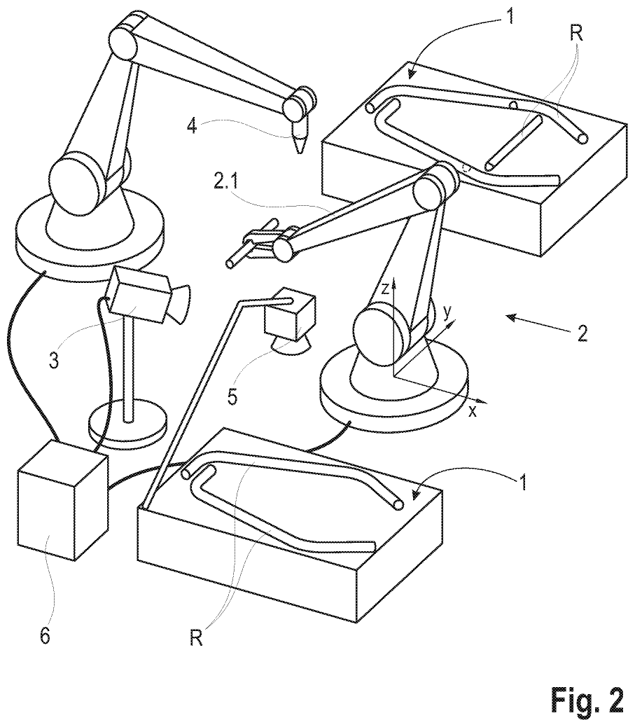

FIG. 2 shows a schematic diagram of a device suitable for performing the method. The device includes feeding means 2 with a gripping arm 2.1, an optical measuring device 3, a laser cutting device 4, a storage and control unit 6 and a further optical measuring device 5.

For machining a tube R, i.e. for cutting a desired cutting contour K_{DESIRED} on the tube R, the tube R is picked up from a feed surface 1 by the gripping arm 2.1 of the feeding means 2. Preferably, several tubes R lie pre-sorted, pre-positioned and pre-oriented on the feed surface 1, so that the gripping arm 2.1, moving to a predetermined gripping position, picks up the respective tube R, lying pre-oriented to the gripping arm 2.1. It is not necessary to position the tubes R so precisely on the feed surface 1 that they are picked up in a reproducible spatial position to the feeding means 2, which benefits the comparatively large shape tolerance of the individual tubes R.

The gripping arm 2.1 is preferably a multi-axis gripping arm 2.1, which can freely move a gripped workpiece, in this case the tube R, within a limited working area. Arranged within the working area are the feed surface 1, the optical measuring device 3, e.g. a 3D camera, and the laser cutting device 4.

By means of the gripping arm 2.1 the tube R is transported in front of the 3D camera, where the contour of the tube R and advantageously its spatial position are recorded and stored. Then the gripping arm 2.1 moves the tube R until the acquired data has been projected into the tolerance envelope H of the tube R, thus confirming that the tube R is in tolerance. The spatial position of the tube R within a coordinate system defined by the feeding means 2, or any other spatially fixed coordinate system, is thus determined by the spatial position of the tolerance envelope H in the coordinate system.

Thereafter or simultaneously, the gripping arm 2.1 feeds the tube R to the laser cutting device 4 in such a way that the tolerance envelope H is in a predetermined relative position to the laser cutting device 4 and thus to the laser beam serving as a tool. The laser beam then cuts an actual cutting contour K_{ACTUAL} on the tube R, with the laser beam being guided along a desired cutting contour K_{DESIRED} related to the tolerance envelope H or along a corrected desired cutting contour K_{DESIRED}/CORR. The method can be performed using the laser beam because the execution of the cut does not require mechanical contact between a cutting tool and a workpiece and thus a defined position of the machining surface, as is the case with mechanical machining. In laser cutting, the machining surface can assume a different spatial position at least within the focus range.

The method according to the invention makes it possible to cut the actual cutting contours K_{ACTUAL} on the only roughly tolerated tubes R, to which other tubes R can be attached and welded. By modifying the actual cutting contours K_{ACTUAL}, depending on the position of the tubes R within the tolerance envelope H and thus depending on their shape deviations, the rough tolerance of the tubes R is included only to a lesser extent, if at all, in the tolerance chain for connecting the tubes R at the actual cutting contours K_{ACTUAL}. The method also allows the gripping arm 2.1 to automatically pick up merely pre-oriented tubes R and feed them to the laser cutting device 4.

### LIST OF REFERENCE NUMERALS

R tube
H tolerance envelope
K_{DESIRED} desired cutting contour
K_{ACTUAL} actual cutting contour
K_{DESIRED/CORR} corrected desired cutting contour
1 feed surface
2 feeding means
2.1 gripping arm
3 optical measuring device
4 laser cutting device
5 further optical measuring device
6 storage and control unit

1. A method for trimming a bent tube along an actual cutting contour, comprising:
calculating for the tube a virtual tolerance envelope with a desired cutting contour and storing the virtual tolerance envelope in relation to a spatially fixed coordinate system,
picking up the tube using a gripping arm of a tube feeder with a known spatial position in the coordinate system,
recording the contour of the tube using an optical measuring device with a known spatial position in the coordinate system,
inserting the tube into the virtual tolerance envelope by moving the gripping arm which holds the tube, thereby confirming compliance with a shape tolerance for the tube lying within the shape tolerance, and the tube assumes a spatial position defined by the spatial position of the tolerance envelope, and the tube is fed relatively to a laser cutting device with an accuracy of the position in the tolerance envelope such that the laser cutting device assumes a predetermined position relative to the tolerance envelope, and
cutting the actual cutting contour on the tube with a laser beam emitted by the laser cutting device.

2. The method according to claim 1, wherein the laser beam is guided along the desired cutting contour, cutting the actual cutting contour as a projection of the desired cutting contour on the tube, the projection corresponding to a modification of the desired cutting contour.

3. The method according to claim 1, wherein the contour of the tube and its position in the tolerance envelope are recorded and stored, the desired cutting contour is corrected for the tube and the laser beam is guided along the corrected desired cutting contour, which corresponds to the actual cutting contour.

4. The method according to claim 1, wherein before the tube is picked up from a feed surface by the gripping arm, a position of the tube on the feed surface is recorded by a further optical measuring device.

5. The method according to claim 2, wherein before the tube is picked up from a feed surface by the gripping arm, a position of the tube on the feed surface is recorded by a further optical measuring device.

6. The method according to claim 3, wherein before the tube is picked up from a feed surface by the gripping arm, a position of the tube on the feed surface is recorded by a further optical measuring device.
